(19) United States
(12) Patent Application Publication
(10) Pub. No.: US 2010/0199866 A1
(43) Pub. Date: Aug. 12, 2010

(54) Filtration for Printing Presses

(75) Inventor: Dietger Hesekamp, Rheda-Wiedenbruck (DE)

Correspondence Address: RICHARD M. GOLDBERG, 25 EAST SALEM STREET, SUITE 419, HACKENSACK, NJ, 07601, US

(73) Assignee: TECHNOTRANS AG, Sassenberg (DE)

(21) Appl. No.: 12/669,291

(22) PCT Filed: Jul. 17, 2008
(86) PCT No.: PCT/EP2008/005875

§ 371 Date: Jan. 21, 2010

(30) Foreign Application Priority Data
Jul. 17, 2007 (DE) 10 2007 033 293.0

(51) Int. Cl. B41L 23/02

(52) U.S. Cl. 101/147

(57) ABSTRACT

A dampening solution circuit for a printing machine, includes a dampening unit, a dampening solution main reservoir, a dampening solution supply for feeding the dampening solution to the dampening unit from the dampening solution main reservoir and a dampening solution return for returning the dampening solution from the dampening unit into the dampening solution supply and a cleaning branch with a dampening solution cleaning apparatus is provided in the region of the dampening solution return, which cleaning branch is configured in such a way that during the operation of the dampening solution circuit a first dampening solution partial flow from the dampening solution main flow can be passed through the dampening solution cleaning apparatus, and the cleaning branch is connected in such a manner that the dampening solution cleaned in the dampening solution cleaning apparatus can be returned into the dampening solution supply.

### FIELD OF THE INVENTION

The invention relates to a dampening solution circuit for a printing machine, and to a printing machine having such a dampening solution circuit.

### BACKGROUND OF THE INVENTION AND STATE OF THE ART

In the state of the art, dampening units are used in offset printing machines. It is the purpose of the dampening unit to apply a dampening solution uniformly on the printing plate of an offset printing machine. Herein, the dampening solution is applied to a first roller, for example, via a dampening fountain, nozzles or in a similar way. A water film is applied by the roller, usually via various other rollers, to the printing plates of the printing machine as evenly as possible.

Surplus dampening solution is usually captured, reprocessed and recirculated to the dampening unit.

Since in operation the dampening solution can be polluted, for example, by pigment components and paper dust, the dirty dampening solution is usually cleaned, such as by means of filtration.

DE 100 61 870 A1 discloses a cleaning system wherein a feed pump extracts dampening water from an intermediate reservoir and pumps the dampening water into a cleaning unit. A further pump is provided in the cleaning unit for pressing the dampening water through a pressure filter. According to the disclosure of this publication the entire dampening water flow is passed through the cleaning unit. Such a cleaning unit must therefore have certain dimensions and is relatively expensive to manufacture.

In contrast, U.S. Pat. No. 7,082,159 discloses a cleaning unit wherein the dampening water is fed from a central tank, from which the printing units of a printing machine are fed, by means of a pump and passed through various cleaning apparatuses. The cleaned dampening water is then returned to the central tank after cleaning. The disclosed device has the drawback that the dampening water must be withdrawn from the central tank via an outlet, which is regularly arranged in a certain region of the central tank and therefore only extracts dampening water from this particular region, so that dampening water from other regions in the central tank is not passed through the cleaning apparatus, and therefore not cleaned, to the same extent. This applies, for example, to dampening water in the region of a dampening water level in the central tank, since the outlet is usually arranged substantially below the dampening water level.

DE 103 60 051 A1 discloses an apparatus wherein impurities, which have adhesive properties, are removed from a tank by a so called band skimmer. This apparatus has the drawback that only impurities having adhesive properties adhere to the band and are removed from the dampening solution by such an apparatus.

A plurality of other apparatuses is also known, which have the purpose to solve general problems or offer detail solutions. There is no particular general trend in the state of the art, which is common to the various solution approaches. The technical development concerning the dampening solution supply of printing machines has not been concluded.

Meanwhile the use of dampening solutions having an alcohol component is a problem in the printing industry, in particular in offset printing, since such additives have health and environmental hazards. One objective of the development is therefore to achieve particularly economical use of dampening water. Moreover, large amounts of dampening solution are used during operation which must be replaced at regular intervals, in particular if they contain impurities. The costs arising from disposal and replacement are substantial so that even small improvements in the dampening solution supply are economically viable.

### OBJECT

It is an object of the invention to provide a dampening solution circuit for a printing machine, and a printing machine having such a dampening solution circuit, by means of which an effective use of the dampening solution is achieved.

### SOLUTION TO THE OBJECT

The object is achieved by the apparatus and method according to the independent claims. Advantageous embodiments are disclosed in the dependent claims.

A first aspect of the invention relates to a dampening solution circuit for a printing machine, wherein the dampening solution circuit comprises a dampening unit, a dampening solution main reservoir, a dampening solution supply means and a dampening solution return means, wherein the dampening solution supply means is arranged between the dampening solution main reservoir and the dampening unit in such a way that the dampening solution can be supplied to the dampening unit from the dampening solution main reservoir via the dampening solution supply means, wherein the dampening solution return means is arranged between the dampening unit and the dampening solution main reservoir in such a way that the dampening solution can be returned from the dampening unit via the dampening solution return means into the dampening solution supply means, wherein a cleaning branch having a dampening solution cleaning apparatus is provided in the region of the dampening solution return means, wherein the cleaning branch is designed in such a way that during operation of the dampening solution circuit, from a dampening solution main flow, a first dampening solution partial flow can fed from the dampening solution main flow through the dampening solution cleaning apparatus, and wherein the cleaning branch is connected to the dampening solution circuit in such a way that the dampening solution which is cleaned in the dampening solution cleaning apparatus can be returned into the dampening solution supply means.

The expression “can be returned into the dampening solution supply means” must be interpreted in such a manner that the dampening solution circuit is an open circuit wherein the dampening solution present in the circuit is continuously circulated during operation. Such a “return into the dampening solution supply means” can be carried out directly or the dampening solution can also be returned into the circuit at a different place in a way ensuring that the dampening solution passes into the dampening solution supply means on its subsequent path. In the open circuit, a portion of the dampening solution can be transferred into the printing process, for example, for dampening during the printing process, and which cannot usually be returned into the circuit. Additional amounts of dampening solution can be lost to the circuit, for example, in the cleaning apparatus. Such used-up dampening solution is preferably replaced in the circuit, wherein the dampening solution which is supplied to the dampening solution supply means is usually quality checked. This is preferably carried out continuously. The term quality preferably covers a composition of the dampening solution (e.g. a ratio of water to alcohol) and/or the temperature and/or the pollution with pigment particles and/or the like. Herein, the dampening solution circuit is preferably configured in such a manner that monitoring and/or checking and controlling of the dampening solution quality and quantity is carried out in that part of the dampening solution circuit which in the present case is referred to as the dampening solution main reservoir. The terms dampening solution main flow and dampening solution partial flow usually refer to flow through volumes per time unit.

A further advantageous embodiment relates to a dampening solution circuit, wherein the dampening solution return means is configured in such a manner that there is no dampening solution pump between the dampening unit and the dampening solution cleaning apparatus. The term dampening solution pump usually refers to dampening solution feeding apparatuses which are able to effect a change in the pressure in a volume unit of the dampening solution, suitable to feed the dampening solution to a different height level. Therefore, the term does not cover, for example, feeding apparatuses, in which only a negligible pressure difference is created, wherein, for example, the dampening solution is always exposed to the same atmospheric pressure, such as in an Archimedes spiral or other feeding means that do not create swirling in the dampening solution. By not providing such dampening solution pumps in the supply line to the cleaning apparatus, swirling of the dampening solution together with the impurities still contained in the dampening solution is avoided. Such swirling has proved disadvantageous, since the dampening solution and the impurities can be emulsified by means of the swirling and are very difficult to separate from each other in the emulsified state. It has come as a surprise that an emulsification leads to a particularly disadvantageous close bond of the components if air is swirled together with the dampening solution and the impurities. It is therefore particularly preferred not to arrange dampening solution pumps upstream of the cleaning apparatus, which are arranged in such a way that air is introduced into the dampening solution during pumping. Pumps which are arranged within the cleaning apparatus and are fully immersed in the dampening solution and/or which run at such a low speed that emulsification can be avoided, are therefore not covered by the term dampening solution pump.

Preferably, such a dampening solution circuit has a configuration, wherein a second dampening solution partial flow can be created parallel in time and separated in space from the first dampening solution flow. By separating the dampening solution main flow into two dampening solution partial flows, selective cleaning of one of the two dampening solution partial flows and/or separate treatment of the dampening solution partial flows is possible.

Furthermore, such a dampening solution circuit is preferred, which is configured in such a manner that the second dampening solution partial flow is not passed through a cleaning apparatus in its path to the dampening solution supply means. This has the advantage that the circulation of the dampening solution circuit can have a high volume flow without the cleaning apparatus also having to handle a large volume flow.

A further advantageous embodiment relates to such a dampening solution circuit, wherein the ratio between the first dampening solution partial flow and the second dampening solution partial flow is controllable (e.g. open-loop and/or closed-loop controllable).

Another preferred embodiment relates to a dampening solution circuit, wherein the first dampening solution partial flow is closed-loop controllable by means of a first determined difference between the dampening solution main flow and the second dampening solution partial flow. A closed-loop control of the second dampening solution partial flow is preferably “dampening-unit-based”, i.e. independent from the first dampening solution partial flow to be cleaned. The closed-loop control prioritizes the operation of the dampening unit. A cleaning apparatus can thus be installed in an existing dampening solution circuit without affecting dampening unit control.

Furthermore, such a dampening solution circuit has preferably a configuration, wherein the dampening unit return apparatus further comprises an intermediate reservoir and an extraction apparatus, which are configured in such a way that dampening solution coming from one or more dampening units is collectable in the intermediate reservoir and the first dampening solution partial flow can be fed out of the intermediate reservoir by means of the extraction apparatus. Preferably, the dampening solution circuit and the intermediate reservoir are configured in such a manner, that different concentrations of impurities in the dampening solution arise at different placed in the intermediate reservoir during the operation of the dampening solution circuit (e.g. due to different flow conditions in the intermediate reservoir and/or different densities of the dampening solution and the impurities). The extraction apparatus is preferably arranged in the dampening solution at a place where a higher impurity concentration is prevalent during operation of the dampening solution circuit than at other places in the intermediate reservoir. Different flow conditions in different regions of the intermediate reservoir can be created, by exciting a rotating flow wherein, depending on the density difference in relation to the dampening solution, impurities reach a higher concentration in the center of an excited vortex or in a radial direction at the periphery of the vortex than in other regions of the flow. Further, it is preferred to create flow conditions in the entry region, wherein in certain regions in the intermediate reservoir a standstill or near standstill of the dampening solution is achieved. This enables or promotes rising and/or sinking of the impurity particles of fluids within the dampening solution so that corresponding impurities collect in certain bottom regions or in certain regions of dampening solution surface FO. The intermediate reservoir preferably has a volume of between 20 l and 300 l, more preferably between 50 l and 150 l. For example, in small machines, an intermediate reservoir size of 50 l can be preferred, and in roller machines having a roller width of about 2 m, the intermediate reservoir can have a volume of between 100 l and 150 l. The volume size and/or flow duration can be preferably dimensioned in such a manner that the average dwell time of the dampening solution is between half a minute and 3 minutes, more preferably about 1 minute. Further preferably, a plurality of extraction apparatuses are provided, which are arranged within the dampening solution at various positions having high concentrations of various impurities in such a manner that damping solution partial flows with different impurities are fed to different cleaning apparatuses. For example, pigment residue and/or oily residue can be extracted in the region of the dampening solution surface, and printing powder, which tends to be deposited on the bottom, can preferably be extracted together with a dampening solution flow in the bottom region of the intermediate reservoir. Furthermore, a pump is preferably provided in the intermediate reservoir to return dampening solution from the intermediate reservoir into the dampening solution feeding apparatus, wherein preferably at least a portion of the dampening solution can be returned into the dampening solution main reservoir. Herein, the pump can be provided at a position where the first dampening solution partial flow after passing through the dampening solution cleaning apparatus is reunified with the second dampening solution partial flow (e.g., when the second dampening solution partial flow is returned to the intermediate reservoir after cleaning.) or the pump only feeds the second dampening solution partial flow (e.g. if the second dampening solution partial flow is directly introduced into the dampening solution main reservoir). Preferably the dampening solution return means opens out into the dampening solution main reservoir.

A further embodiment of the dampening solution circuit is preferred, wherein the cleaning branch in the feeding apparatus opens out into the intermediate reservoir downstream of the dampening solution cleaning unit.

A further preferred embodiment relates to such a dampening solution circuit wherein the cleaning branch is directly connected to the dampening solution main reservoir so that the first dampening solution partial flow can be directly fed into the dampening solution main reservoir downstream of the dampening solution cleaning apparatus.

An embodiment of the dampening solution circuit is further preferred, wherein the extraction apparatus is configured in such a manner that dampening solution can be extracted in the region of the dampening solution surface at various filling levels in the intermediate reservoir by means of the extraction apparatus. Such an extraction apparatus can be configured to be controllable in such a manner that an extraction opening of the extraction apparatus moves upwards or downwards as the filling level of the dampening solution varies in the intermediate reservoir. This can be implemented by means of a surface skimmer having an extraction opening which tracks the shifting dampening solution surface by means of a float. An electronic closed-loop control of the position of such an extraction opening is also conceivable, wherein the closed-loop control is preferably carried out in dependence on signals from one or more filling level sensors. The use of a band skimmer is also conceivable, wherein the band of the band skimmer circles around a certain height difference without having to vary the position of the band skimmer, whereby, however, the band can be brought into contact with impurities arising in the region of the dampening solution surface even if the dampening solution level rises or falls. A combination of the above mentioned possibilities with each other or with other possibilities is also conceivable.

A further advantageous embodiment relates to a dampening solution circuit, wherein the extraction apparatus has an flow-out edge, which is arranged below the dampening solution surface in such a manner that discharge of the dampening solution is carried out by having the dampening solution flow out over the flow-out edge. The flow-out edge is preferably arrangeable in dependence on the filling level in the intermediate reservoir at a certain distance to the dampening solution surface. A flow-out edge can be, for example, the edge of a tube or a hose, which can be brought into the vicinity of to the dampening solution surface from below. It is preferred if the edge is configured and approached to the dampening solution surface in such a manner that it has no regions extending above the dampening solution surface, since such protruding regions tend to collect dirt. Furthermore it is preferred, if the flow-out edge is positioned at a preferred distance from the dampening solution surface by means of a float or by means of the above mentioned electronic apparatus. It is preferred if the flow-out edge is positionable at various distances to the dampening solution surface over a range of distances so that a defined dampening solution flow-out can be created by means of the length of the flow-out edge in combination with the filling level above the edge.

Preferably, such a dampening solution circuit has a configuration, wherein the intermediate reservoir is subdivided into an inflow region and an outflow region by means of a dividing wall, wherein the inflow of the dampening solution coming from the one or more dampening units is into the inflow region, wherein the dividing wall has a flow-through opening allowing a fluid flow between the inflow region and the outflow region, and wherein the flow-through opening is arranged below a minimum filling level of the dampening solution in the inflow region. This enables a separation between inflow region and outflow region so that the dampening solution dwells sufficiently long in the inflow region before flowing through the flow-through opening, enabling impurities to rise to the dampening solution surface or to sink to the bottom. It is preferred if the explanations given above with reference to the intermediate reservoir essentially apply to the inflow region so that respective impurities collect in certain bottom regions or in certain regions of the dampening solution surface FO. The inflow region preferably has a volume of between 20 l and 300 l, more preferably between 50 l and 150 l. With smaller machines, for example, an inflow region size of 50 l can be preferred and with roller machines having a roller width of about 2 m, the inflow region can have a volume of between 100 l and 150 l. The volume size and/or flow duration can preferably be dimensioned in such a way that the average dwell time of the dampening solution in the inflow region is between half a minute and 3 minutes, preferably about 1 minute. Further preferably, a plurality of extraction apparatuses are provided in the inflow region, which are arranged within the dampening solution at a plurality of positions with high concentrations of various impurities in such a manner that dampening solution partial flows comprising different impurities are fed to different cleaning apparatuses. For example pigment residues and/or oily residues can be extracted in the region of the dampening solution surface, and printing powder which tends to be deposited on the bottom can preferably be extracted together with a dampening solution flow in the bottom region of the intermediate reservoir. Furthermore, the flow-through opening is preferably arranged in the bottom region of the inflow region since the impurities usually have a smaller density than the dampening solution and therefore rise to the surface. The volume of the inflow region is preferably dimensioned in such a manner that an average dwell time of the dampening solution in the inflow region is ensured allowing lighter components such as oil and pigments to rise to the surface. An upwards tapering configuration of the inflow region is preferred, which results in the impurities rising to the top being collected in a concentrated manner in the tapering region.

A dampening solution circuit is preferred in which the cleaning unit has a separator. In a preferred embodiment, a separator can be provided, for example, in the form of a centrifuge.

A further advantageous embodiment relates to such a dampening solution circuit, wherein the cleaning unit has a cross-flow filter. In cross-flow filtration, a flow on a suspension side can be created essentially parallel to a filter means, wherein the filter means can be passed by the liquid in the transverse direction, while the impurities are preferably largely carried away by the flow. The advantage of cross-flow filtering is that deposition of impurities on the filter means is prevented or reduced by the flow parallel to the filter means. Preferably durable filter materials are used. The additional or alternative use of disposable filter materials is also conceivable.

An embodiment of a dampening solution circuit is also preferred, wherein the cleaning apparatus includes a filter unit with exchangeable filters. Such filters can be provided, for example, in the form of filter bags or filter mats. Other filter forms are also conceivable. The advantage of these embodiments lies in there cost-effective apparatus price.

Furthermore, such a dampening solution circuit has preferably a configuration, wherein the cleaning apparatus is in the form of a cascade system.

A further aspect of the invention relates to a printing machine having such a dampening solution circuit.

Individual, particularly preferred embodiments of the invention will be described in an exemplary manner in the following. The individual described embodiments partly comprise features that are not absolutely necessary to implement the present invention, but which are generally deemed preferable. Embodiments should also be understood as falling under the teachings of the present invention which do not include all features of the embodiments described in the following. It is also conceivable to selectively combine features with each other, which are described with reference to different embodiments.

### SHORT DESCRIPTION OF THE DRAWINGS

FIG. 1 is a schematic diagram of a preferred first embodiment of a dampening solution circuit according to the present invention,

FIG. 2 is a schematic diagram of a preferred second embodiment of a dampening solution circuit according to the present invention,

FIG. 3 is a schematic diagram of a preferred third embodiment of a dampening solution circuit according to the present invention,

FIG. 4 is a schematic diagram of a preferred intermediate reservoir having a preferred extraction apparatus in cross-section,

FIG. 5 is an enlarged view of the extraction apparatus of FIG. 4 in the region of an extraction opening.

### DETAILED DESCRIPTION OF THE DRAWINGS

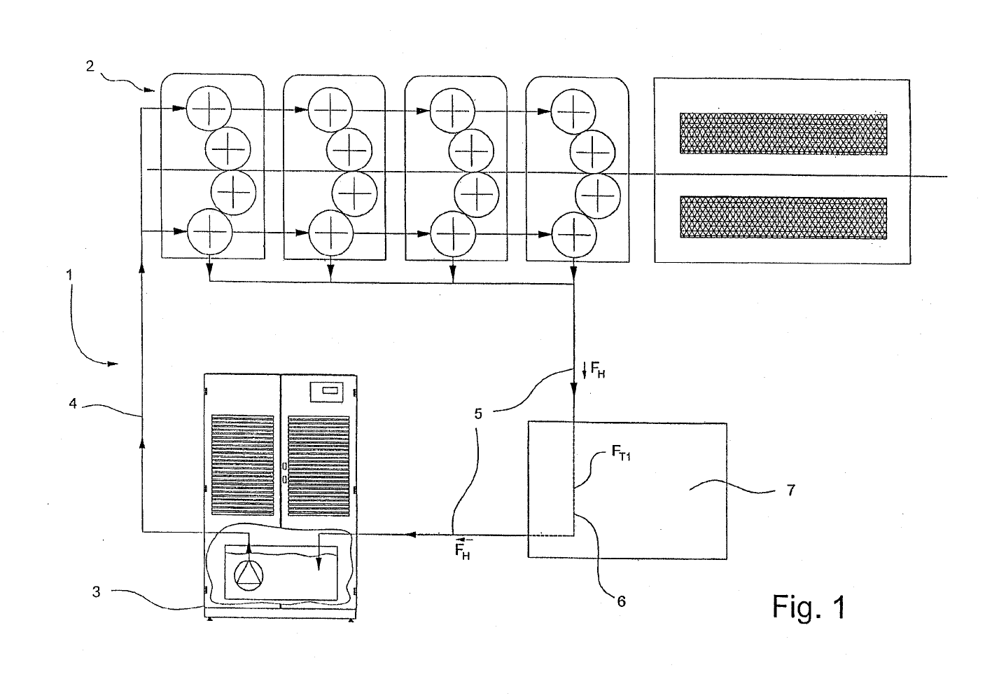

FIG. 1 is a schematic diagram of a preferred first embodiment of a dampening solution circuit 1 according to the present invention.

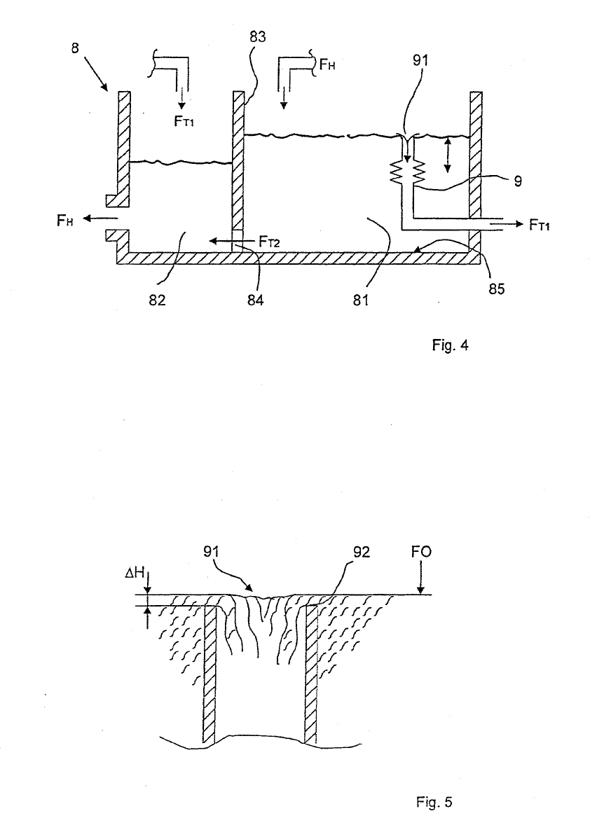

A dampening solution main reservoir 3 is shown, in which a certain amount of ready-to-use dampening solution is provided, which feeds the dampening solution by means of a pump (not shown in any more detail) via a dampening solution supply means 4 to a dampening unit 2. Four printing towers are shown in FIG. 4 in a schematic manner, each comprising at least one dampening unit 2.

Surplus dampening solution is caught in dampening units 2 and drained via various lines from the various dampening units. The various volume flows are combined downstream in a dampening solution return means 5 to form a dampening solution main flow F_{H}. Dampening solution return means 5 can comprise various components, such as tubes, sumps etc.

In the preferred embodiment, which is shown in FIG. 1, a first region of the dampening solution return means 5 opens out into a cleaning branch 6 so that the entire dampening solution main flow F_{H} is passed through a dampening solution cleaning apparatus 7 as a first dampening solution partial flow F_{T1}. In dampening solution cleaning apparatus 7, the dampening solution is cleaned of impurities by various apparatuses (not shown in any more detail).

Subsequently, the cleaning branch 6 opens out into a second section of dampening solution return means 5 so that first dampening solution partial flow F_{T1} which, in the present embodiment, corresponds to dampening solution main flow F_{H}, is returned into dampening solution main reservoir 3.

According to the preferred embodiment of the invention shown here, no pump is provided between the dampening units and the dampening solution cleaning apparatus 7 as seen in the flow direction, so that the dampening solution is fed from dampening units 2 to dampening solution cleaning apparatus 7 solely due to the force of gravity. This has the advantage that the formation of an emulsion of the dampening solution and pigment components contained therein and/or oily impurities, is avoided.

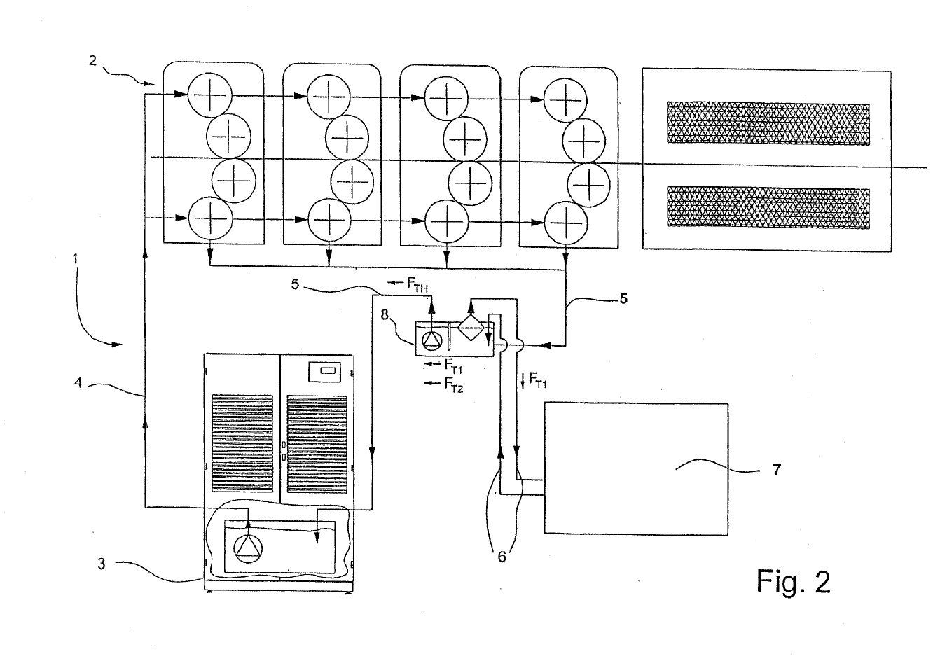

FIG. 2 is a schematic diagram of a preferred second embodiment of dampening solution circuit 1 according to the present invention.

According to this preferred, second embodiment, an intermediate reservoir 8 is provided in dampening solution return means 5. Preferably, the dampening solution main flow F_{H} is fed from dampening units 2 to intermediate reservoir 8 solely due to the force of gravity. In the embodiment shown, dampening solution from all dampening units 2 shown, is fed into intermediate reservoir 8. The dampening solution collected in intermediate reservoir 8 passes through intermediate reservoir 8 and is subsequently fed to dampening solution main reservoir 3.

Dampening solution return means 5 is configured in such a manner that the dampening solution main flow in its entirety is fed both to intermediate reservoir 8 and passed on from here into dampening solution main reservoir 3. Furthermore, according to the present embodiment, a cleaning branch 6 is provided, which separates off a first dampening solution partial flow F_{T1} from dampening solution main flow F_{H}, passes it through a dampening solution cleaning apparatus 7 and subsequently returns it to intermediate reservoir 8.

Cleaning branch 6 is configured in the present preferred embodiment in such a manner that first dampening solution partial flow F_{T1} is only a portion of dampening solution main flow F_{H}, so that a second dampening solution partial flow F_{T2} is formed within intermediate reservoir 8, which is returned to dampening solution main reservoir 3 without passing through the cleaning apparatus.

Preferably, the first dampening solution partial flow F_{T1} is fed to dampening solution cleaning apparatus 7 solely due to the force of gravity. Such an apparatus has the advantage that the dampening solution is not swirled by pumps so that the impurities can easily be separated from the dampening solution in the dampening solution cleaning apparatus 7.

An extraction apparatus 9, which extracts the dampening solution from intermediate reservoir 8, and a preferred configuration of the intermediate reservoir will be described further below with reference to FIGS. 4 and 5.

According to the preferred embodiment, first dampening solution partial flow F_{T1} is both withdrawn from the intermediate reservoir and returned to the same. According to a different embodiment, not shown here, the first dampening solution partial flow F_{T1} is not returned into intermediate reservoir 8 but directly returned into dampening solution main reservoir 3.

Furthermore, it is also conceivable, in addition to the lines shown here, that a further line conducts dampening solution from dampening solution main reservoir 3 into intermediate reservoir 8 so that dampening solution cleaning apparatus 7 can be operated even during standstill of dampening solution circuit 1. Dampening solution cleaning apparatus 7 can thus be operated even during standstill of the printing machine.

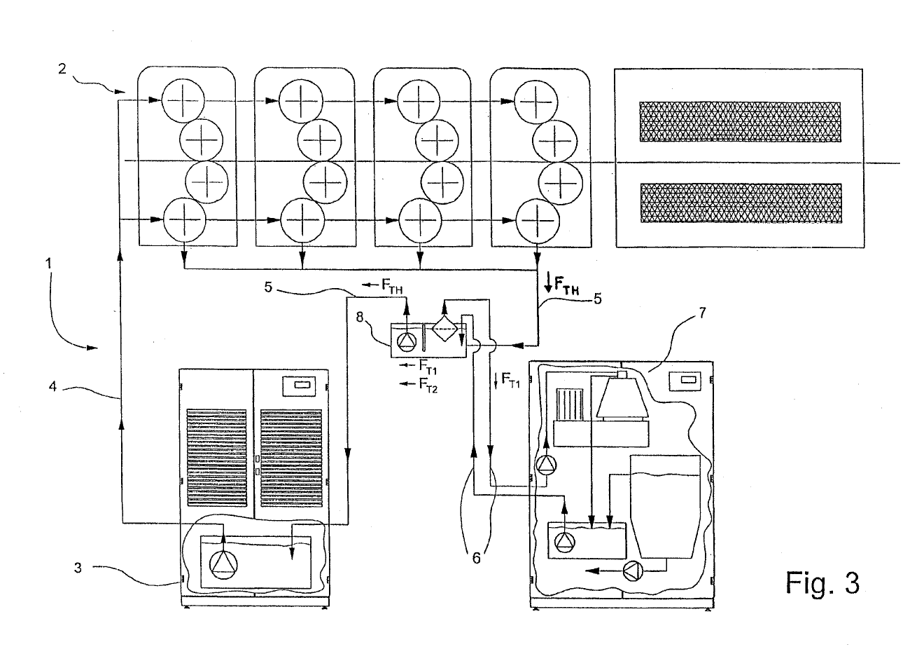

FIG. 3 is a schematic diagram of a preferred third embodiment of the dampening solution circuit according to the present invention.

This third embodiment essentially corresponds to the embodiment shown in FIG. 2 so that, to avoid undue repetition, the elements already described are not described again.

In the third embodiment shown here, the configuration of dampening solution cleaning apparatus 7 is shown in more detail. It can be seen that the cleaning apparatus preferably comprises a plurality of cleaning elements. These can be, for example, a separator and/or a cross-flow filter and/or a filter unit and/or a cascade system.

The individual cleaning elements can be arranged sequentially, in parallel, partially sequentially and partially parallel and/or in a cascading fashion.

As shown in FIG. 3, dampening solution cleaning apparatus 7 comprises a pump on the inflow side, which presses, for example, the dampening solution through a filter unit. While it is preferred, according to the present invention, not to provide a pump between the dampening unit and the cleaning apparatus, preferred embodiments can also be equipped with a pump, in particular, if the pump is configured such that the dampening solution and the impurities are not swirled in such a manner that an emulsion is created. This can be achieved, for example, with pumps running at a particularly low speed. If a pump is provided, it is further preferred (additionally or alternatively to the pump configuration described) if the pump is provided at a position lying below the dampening solution level. This has the advantage that air does not come into contact with the dampening solution and the impurities even if they are swirled. In the present context it has come as a surprise that air contact while swirling creates a particularly disadvantageous form of emulsification, which is particularly hard to separate in the cleaning apparatus.

FIG. 4 is a schematic diagram of a preferred intermediate reservoir 8 including a preferred extraction apparatus 9 in cross-section.

Such a preferred intermediate reservoir 8 can be used in a dampening solution circuit 1 described above. The intermediate reservoir shown includes an inflow region 81 and an outflow region 82, each preferably having the form of a trough. Furthermore, inflow region 81 and/or outflow region 82 can also have a closed configuration. A portion of dampening means return apparatus 5 coming from the one or more dampening units 2 opens out into inflow region 81. While the opening of the dampening solution return means, through which the dampening solution main flow F_{H} is passed into inflow region 81, is schematically shown as a faucet-like structure above the dampening solution surface in inflow region 81, it may well be preferred to arrange the opening below the dampening solution surface FO, for example, in the bottom area of the inflow region. Preferably, the opening transitions into the inflow region in such a manner that preferred flow conditions are created in the inflow region, which are favorable to a separation of the impurities from the dampening solution.

It is preferred, for example, to establish flow conditions in the inflow region, which ensure a dwell duration of the dampening solution and/or minimal fluid motion in the inflow region. This can help to promote rising and/or sinking of impurity particles or fluids within the dampening solution so that the respective impurities collect in certain bottom regions or in certain regions of the dampening solution surface FO. A similar effect can be created by establishing a rotating flow, wherein impurities with smaller or larger densities achieve a higher concentration in the center of the created vortex or in a radial direction at the periphery of the vortex than in other regions of the inflow region 81.

In the preferred embodiment shown, a rest basin is provided, in which a particularly preferred extraction apparatus 9 is arranged such that its extraction opening is arranged just below the dampening solution level. The extraction opening will be described below with reference to FIG. 5.

Furthermore, inflow region 81, in the embodiment shown in FIG. 4, is configured to be separate from an outflow region 82 by means of a separating wall 83. Inflow region 81 and outflow region 82 are preferably connected with each other, as shown, in the bottom region 82 of inflow region 81 by means of a flow-through opening 84. Flow-through opening 84 is preferably formed in separating wall 83.

In this preferred embodiment, a second dampening solution partial flow F_{T2} flows through flow-through opening 84. First dampening solution partial flow F_{T1}, in the preferred embodiment shown, flows back into outflow region 82 in a cleaned state. It is also conceivable to pass cleaned first dampening solution partial flow F_{T1} directly into the dampening solution main reservoir, or to pass first dampening solution partial flow F_{T1} into inflow region 81 so that the entire dampening solution main flow F_{H} flows through flow-through opening 84. It is also conceivable to configure the intermediate reservoir without a separating wall or to provide a plurality of separating walls in a labyrinthine configuration.

FIG. 5 is an enlarged view of extraction apparatus 9 of FIG. 4 in the region of extraction opening 91.

The extraction apparatus is configured in such a manner that the dampening solution drains into the extraction opening due to the force of gravity. Herein, the flow conditions are such that impurities with lesser densities can be found in a particularly high concentration in the area of dampening solution surface FO and flow together with the dampening solution across flow-out edge 91 of extraction opening 91. A first dampening solution partial flow F_{T1} thus created therefore includes a particularly high contamination with impurities. This has the advantageous effect that a small dampening solution partial flow F_{T1} leads to a high cleaning effect. By using such a configuration it is possible to make cleaning of the entire dampening solution main flow superfluous so that dampening solution cleaning apparatus 7 can be designed to handle a smaller volume flow.

As can also be seen from FIG. 5, the outflow edge is arranged at a distance ΔH to dampening solution surface FO. It is preferred if the extraction opening is configured in such a manner that distance ΔH can be variably adjusted or closed-loop controlled to different values so that the size of the volume flow of first dampening solution partial flow F_{T1} can be adjusted.

Furthermore, it is preferred if extraction opening 9 is adjustable over a variable range following the filling level of the dampening solution in inflow region 81, so that the extraction apparatus can be operated at various filling levels.

Adjustment and/or closed-loop control of extraction apparatus 9 can be carried out mechanically (such as by means of a float) or electronically in dependence on filling level signals from one or more filling level sensors. Filling level sensors can sense, for example, the pressure in the dampening solution and convert it to a signal, or they can measure electric resistance. Any type of sensor is conceivable here.

In the preferred embodiment shown here the extraction apparatus is in the form of a tube so that an essentially circular extraction opening 91 is provided. Any other form of an extraction edge is also conceivable, such as an essentially planar, height-adjustable slide which separates off a further region within the inflow region, in which the first dampening solution partial flow F_{T1} flows toward the dampening solution cleaning apparatus 7.

### LIST OF REFERENCE NUMERALS

1 dampening solution circuit
2 dampening unit
3 dampening solution main reservoir
4 dampening solution supply means
5 dampening solution return means
6 cleaning branch
7 dampening solution cleaning apparatus
8 intermediate reservoir
81 inflow region
82 outflow region
83 separating wall
84 flow-through opening
85 bottom area of inflow region
9 extraction apparatus
91 extraction opening
92 outflow edge
FO dampening solution surface
F_{H} dampening solution main flow
F_{T1} first dampening solution partial flow
F_{T2} second dampening solution partial flow
ΔH distance between outflow edge and dampening solution surface

What is claimed is:

1. A dampening solution circuit for a printing machine, comprising:
a dampening unit,
a dampening solution main reservoir
a dampening solution supply arranged between the dampening solution main reservoir and the dampening unit in such a manner that the dampening solution is adapted to be fed to the dampening unit from the dampening solution main reservoir via the dampening solution supply,
a dampening solution return arranged between the dampening unit and the dampening solution main reservoir in such a manner that dampening solution is adapted to be returned from the dampening unit via the dampening solution return into the dampening solution supply, and
a cleaning branch with a dampening solution cleaning apparatus is provided in a region of the dampening solution return, which cleaning branch is configured in such a way that during operation of the dampening solution circuit a first dampening solution partial flow from a dampening solution main flow is adapted to be passed from the dampening solution main flow through the dampening solution cleaning apparatus, and wherein the cleaning branch is connected with the dampening solution circuit in such a manner that the dampening solution cleaned in the dampening solution cleaning apparatus is adapted to be returned into the dampening solution supply.

2. The dampening solution circuit according to claim 1, wherein the dampening solution return is configured in such a manner that no dampening solution pump is provided between the dampening unit and the dampening solution cleaning apparatus.

3. The dampening solution circuit according to claim 1, wherein a second dampening solution partial flow is adapted to be created parallel in time and separated in space from the first dampening solution partial flow.

4. The dampening solution circuit according to claim 3, which is configured in such a manner that the second dampening solution partial flow does not pass a cleaning apparatus on its path into the dampening solution supply.

5. The dampening solution circuit according to claim 3, which is configured in such a manner that a ratio between the first dampening solution partial flow and the second dampening solution partial flow is controllable respectively at least one of:
open-loop controllable and
closed-loop controllable.

6. The dampening solution circuit according to claim 5, which is configured in such a manner that the first dampening solution partial flow is controllable based on a determined difference between the dampening solution main flow and the second dampening solution partial flow.

7. The dampening solution circuit according to claim 1, wherein the dampening solution return further includes an intermediate reservoir and an extraction apparatus, which is configured in such a manner that dampening solution is collectable in the intermediate reservoir, coming from at least one dampening unit, and that the first dampening solution partial flow is adapted to be drained from the intermediate reservoir by the extraction apparatus.

8. The dampening solution circuit according to claim 7, wherein the cleaning branch opens out into the intermediate reservoir downstream from the dampening solution cleaning apparatus as seen in a feeding direction thereof.

9. The dampening solution circuit according to claim 1, wherein the cleaning branch is directly connected to the dampening solution main reservoir so that the first dampening solution partial flow is adapted to be fed directly into the dampening solution main reservoir downstream from the dampening solution cleaning apparatus.

10. The dampening solution circuit according to claim 7, wherein the extraction apparatus is configured in such a manner that dampening solution is adapted to be withdrawn by the extraction apparatus at various filling levels in the intermediate reservoir in a region of a dampening solution surface thereof.

11. The dampening solution circuit according to claim 7, wherein the extraction apparatus has an outflow edge, which is arranged below a dampening solution surface of the intermediate reservoir in such a manner that draining of the dampening solution is carried out by flowing out of the dampening solution across the outflow edge.

12. The dampening solution circuit according to claim 7,
wherein the intermediate reservoir is separated into an inflow region and an outflow region by a separating wall,
wherein introduction of the dampening solution coming from at least one dampening unit is in the inflow region,
wherein the separating wall has a flow-through opening through which a fluid flow between the inflow region and the outflow region is enabled,
wherein the flow-through opening is arranged below a minimal filling level of the dampening solution in the inflow region.

13. The dampening solution circuit according to claim 1, wherein the cleaning unit includes a separator.

14. The dampening solution circuit according to claim 1, wherein the cleaning unit comprises a cross-flow filter.

15. The dampening solution circuit according to claim 1, wherein the cleaning apparatus comprises a filter unit with replaceable filters.

16. The dampening solution circuit according to claim 1, wherein the cleaning apparatus is configured as a cascade system.

17. A printing machine including a dampening solution circuit according to claim 1.
